(19) United States
(12) Patent Application Publication
(10) Pub. No.: US 2013/0251527 A1
(43) Pub. Date: Sep. 26, 2013

(54) Sail Enhanced Wind Turbine System

(71) Applicant: Troy Edward Schmidt, North Mankato, MN (US)

(72) Inventor: Troy Edward Schmidt, North Mankato, MN (US)

(21) Appl. No.: 13/427,831

(22) Filed: Mar. 22, 2012

(51) Int. Cl. F03B 17/06

(52) U.S. Cl. 416/84

(57) ABSTRACT

The Sail Enhanced Wind Turbine System will increase the output of the wind turbine within the system by increasing the amount of force, or wind, being applied to the turbine.

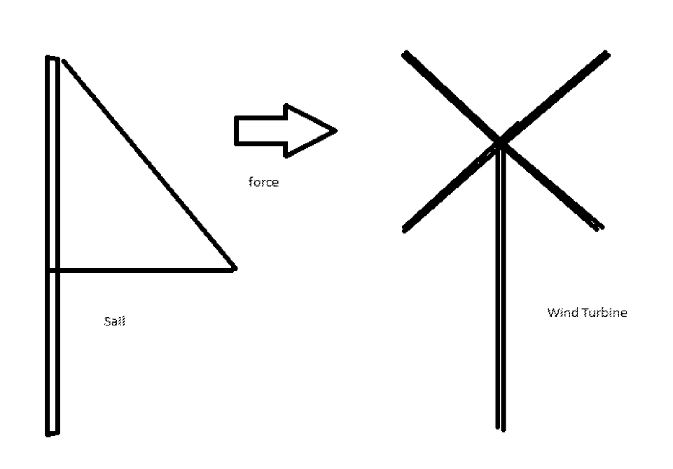

A sail generates force in a direction by collecting air and directing it. By mounting a sail such that the force of the sail may be directed onto the turbine, and operating the sail such that the force is directed onto the turbine, the wind turbine becomes more efficient with an increased output.

The Sail Enhanced Wind Turbine System is a system in which a sail is used to increase the wind velocity and air pressure applied to a wind turbine. The sail is placed such that the thrust of the sail is focused directly onto the wind turbine.

Any type and size of sail may be used. Any type and size of wind turbine may be used. Any method of controlling the sail may be used. The position of the sail and wind turbine is such that the force from the sail is applied to the wind turbine.

### DRAWING DESCRIPTION

The drawing consists of three images. These images are labeled Sail, Wind Turbine, and Force.

Sail: A representation of a standard mainsail, although the system is not limited to any specific sail.

Force: A sail generates a thrust which is directed according to the angle of the sail. This represents the thrust being directed onto the wind turbine.

Wind Turbine: A representation of modern wind turbines, although the system is not limited to any specific wind turbine.

Placement of images: The sail must not block the wind to the turbine, but rather increase the force applied to the wind turbine. Due to the nature of wind in urban and natural environments each placement may be unique, with the requirement that the force of the sail is directed onto the wind turbine. The image does not represent a necessary or specific placement, but rather merely an approximate diagram of functionality.

1: The wind turbine will have increased output when the sail is in place and controlled correctly. Correct control of the sail is according to modern methods and such that force from the sail is applied to the wind turbine.
